(19) United States
(12) Patent Application Publication
(10) Pub. No.: US 2008/0308169 A1
(43) Pub. Date: Dec. 18, 2008

(54) Fluid Line and Method for Manufacturing a Fluid Line

(75) Inventors: Claus A. Nielsen, Vildbjerg (DK); Christian B. Hansen, Aabenraa (DK)

Correspondence Address: MCCORMICK, PAULDING & HUBER LLP, CITY PLACE II, 185 ASYLUM STREET, HARTFORD, CT, 06103, US

(73) Assignee: PIFLEX P/S, Loegumkloster (DK)

(21) Appl. No.: 12/091,319

(22) PCT Filed: Oct. 29, 2005
(86) PCT No.: PCT/EP2005/011599

§ 371 Date: Jul. 30, 2008

(51) Int. Cl. F16L 9/16; B29D 23/00

(52) U.S. Cl. 138/116; 138/177; 156/242; 138/111

(57) ABSTRACT

A method for producing a fluid line (2) and a corresponding fluid line (2) are specified, wherein a number of tubes are wound in parallel along a helical line in each case, a connecting element (6, 7) is fastened to at least one end and the tubes are embedded in a plastic material. It is wished to make production simple. For this purpose, it is envisaged to use a liquid silicone rubber (12) as the plastic material.

### CROSS REFERENCE TO RELATED APPLICATIONS

This application is entitled to the benefit of and incorporates by reference essential subject matter disclosed in International Patent Application No. PCT/EP2005/011599 filed on Oct. 29, 2005.

### FIELD OF THE INVENTION

The invention concerns a method for manufacturing a fluid line, in which several tubes are wound in parallel along a helical line, provided at least at one end with a connecting element and embedded in a plastic material. Further, the invention concerns a fluid line with several tubes wound in parallel along a helical line and having, at least at one end, a common connecting element, the tubes being embedded in a plastic material.

### BACKGROUND OF THE INVENTION

Such a fluid line is known from WO 2004/046601 A1. For the flow of the fluid the sum of the cross-sections of all tubes is available. The helical line shape of the tubes provides the fluid line with a certain flexibility.

Such fluid lines are well suited for transporting fluids in technical applications under a high pressure and, if required, also under high temperatures, if such applications are exposed to heavy vibrations and aggressive environmental conditions. Application examples are mobile refrigeration systems, particularly air-conditioning systems in vehicles working with CO₂. For mounting reasons, such applications require a certain flexibility of the line without weakening the line.

The manufacturing of such a fluid line, however, requires a certain effort. This is particularly the case for the step of embedding in the plastic material. Usually, for this purpose, the tubes must be stabilised from the inside to prevent them from getting damaged during embedding.

### SUMMARY OF THE INVENTION

The invention is based on the task of simplifying the manufacturing.

With a method as mentioned in the introduction, this task is solved in that a liquid silicone rubber is used as plastic material.

Liquid silicone rubbers are plastic materials offering substantial advantages for this application in comparison with previously used silicone rubber or other polymer plastic materials, for example thermo-plastic materials, elastomers or thermo-plastic elastomers. Liquid silicone rubbers are highly elastic, highly temperature resistant two-component plastic materials, which do not cure until the two low-viscous components are brought together under heat absorption. No particular pre-treatment of the tube surfaces is required to ensure a sufficient adhesion of the cured liquid silicone rubber to the surfaces of the tubes. Also in connection with elongations of more than 100%, this adhesion is maintained. Liquid silicone rubbers are, for example, available under the names Dow Corning SILASTIC LSR, Wacker ELASTOSIL LR and GE-Bayer Silopren LSR.

Preferably, the liquid silicone rubber is applied to the tubes by means of an injection moulding process. With this method, the advantages of liquid silicone rubber are particularly obvious. The liquid silicone rubber, or rather the pre-mixed components of the liquid silicone rubber, can namely be inserted into an injection mould under a relatively low pressure. Usually, relatively low injection pressures of maximum 50 bar will be sufficient. For traditional plastic materials, pressures of several 100 bar were often required, so that the tubes had to be stabilised from the inside.

Preferably, the tubes are inserted in an injection mould, and subsequently a component mix of the liquid silicone rubber is inserted into the injection mould through a cooled inlet passage. With this method, it is prevented that the viscosity of the mixed components increases in the inlet passage, thus causing clogging. Further, the finished tube can usually be removed from the injection mould without bosses.

Preferably, the tubes are heated before insertion into the injection mould. Liquid silicone rubber cures under heat absorption. When sufficient heat is supplied, the curing can be accelerated. With a sufficient heat supply, the curing takes place so fast that short fixed cycles in the manufacturing process in the range of a few seconds can be achieved. Heating of the tubes to a temperature in the range from 150 to 200° C. also causes that the adhesion of the liquid silicone rubber to the tubes is improved.

Alternatively or additionally, the injection mould can be heated. Also this causes an acceleration of the curing process.

With a fluid line as mentioned in the introduction, the task is solved in that the plastic material is a cured liquid silicone rubber.

As mentioned above, liquid silicone rubber is a highly elastic plastic material, which is also high-temperature resistant. It is a two-component plastic material, both components having in the separated state, and also for a certain period in the mixed state, a low viscosity, that is, they are highly flowable. Not until being brought together they cure under heat absorption and thus adhere to the tubes in an excellent manner.

Preferably, the cured liquid silicone rubber covers a connection arrangement between the tubes and the connecting element. Thus, also the joining spots at the connection between tubes and connecting element will be reliably protected against corrosion attacks.

Preferably, the tubes have a mutual distance, in which the cured liquid silicone rubber is located. In this way, the tubes are prevented from rubbing on each other during operation. This rubbing could cause damage to the tubes.

Preferably, the cured liquid silicone rubber surrounds a hollow inside an inner chamber surrounded by the tubes. This means that the tubes are covered on the radial inside and the radial outside by the liquid silicone rubber. At the same time, a hollow is located inside the line, in which no cured liquid silicone rubber is available. Apart from the advantage of saved weight, this embodiment has the advantage that other lines, for example electrical wires, can be guided through the hollow.

Preferably, the connecting element is located outside the longitudinal axis of the helical line. During manufacturing of the line, this permits the insertion of a core to create the hollow. In this case, the connecting element will not prevent the movement of the core during insertion and removal.

Preferably, the ends of the tubes extend tangentially from the helical line. In this case, they do not have to be bent at the end of the helical line, but are, in a manner of speaking, continuing straight forward.

In an alternative embodiment it may be provided that the ends of the tubes are bent in parallel to the longitudinal axis of the helical line. In this case, a connecting element can be used that does, in a manner of speaking, continue in a straight line from the fluid line.

Preferably, the connecting element has a basis plate with through openings, into which the ends of the tubes are inserted. This is a relatively simple way of connecting the tubes to the connecting element and at the same time ensuring that this connection is tight.

Preferably, the basis plate, together with a housing element, encloses a connection chamber, the housing element having an opening. Eventually, another line or a tube end can be connected to this opening, through which the fluid will be supplied or discharged. The basis plate and the housing element can be manufactured separately and then assembled. The basis plate and the housing element can also be manufactured in one piece.

Preferably, the ends of the tubes are connected to the basis plate via a soldered or welded connection. On the one side, a soldered or welded connection provides a sufficient mechanical stability. On the other side, this connection also provides a sufficient tightness.

Preferably, the end of the connecting element facing the tubes comprises a circumferential recess, into which the cured liquid silicone rubber extends. In a manner of speaking, this provides a form-fit connection between the liquid silicone rubber and the connecting element. The connections between the tubes and the connecting element are even better protected against corrosion.

Preferably, the connecting element has a projection that extends into a chamber circumscribed by the helical line. The projection can be made as an integrated part of the connecting element or as a separate component, which is, for example, fixed on the basis plate. With this embodiment, the end area of the tubes is relieved. After winding and connection to the connecting element, the largest stresses in the individual tubes appear on the one side at the transition from the winding structure into the axial tube ends due to the mechanical deformation, and on the other side at the soldering and welding spots in the basis plate due to thermal load. By means of the projection, these static “prestressed” areas of the tubes can be separated from the spots, which can be stressed during mounting or operation, for example in the form of dynamic load caused by vibrations. Thus, the projection reduces the risk of a line rupture.

It is preferred that the projection has a length, which at least corresponds to the diameter of the helical line. Or rather, the length corresponds at least to the inner diameter, which is left free by the helically guided tubes. With this length, the projection can provide a sufficient supporting function.

Preferably, the end of the projection is made to be conical. Thus, it tapers in the direction of its free end. This increases the radial distance between the projection and the tubes in the direction of the free end of the projection, so that a certain flexibility of the line also exists in the area of the projection without causing too large stress loads.

Preferably, a radial distance is provided between the projection and the tubes, the radial distance being filled with cured liquid silicone rubber. Also this improves the supporting function of the projection, though maintaining the flexibility of the line.

Alternatively or additionally, it may be provided that the connecting element has a circumferential flange extending in the direction of the tubes, the flange surrounding the helical line in an end area. Thus, the flange forms some sort of “cover” surrounding the end area of the fluid line. Also between this cover and the outsides of the tubes a radial distance can be provided, which is filled with liquid silicone rubber. Additionally, also an improved protection of the connection spots between the tubes and the connecting element against external influences occurs.

### BRIEF DESCRIPTION OF THE DRAWINGS

In the following, the invention is described on the basis of preferred embodiments in connection with the drawings, showing:

FIG. 1 is a schematic view of a fluid line with radially aligned tubes,

FIG. 2 shows the fluid line according to FIG. 1 with a connecting element at each end,

FIG. 3 shows the fluid line according to FIG. 2 after embedding in liquid silicone rubber,

FIG. 4 shows a modified embodiment of a tube bundle with axially aligned tube ends,

FIG. 5 shows an axial section through the line according to FIG. 4 with connecting element and massive plastic material embedding,

FIG. 6 shows an embodiment modified in comparison to FIG. 5, with a hollow inside the liquid silicone rubber,

FIG. 7 shows a modified embodiment of the line according to FIG. 5,

FIG. 8 shows a second modified embodiment of the line according to FIG. 5,

FIG. 9 shows a third modified embodiment of the line according to FIG. 5,

FIG. 10 shows a schematic view explaining the injection moulding plant, and

FIG. 11 shows different process steps of the fluid line manufacturing.

### DETAILED DESCRIPTION OF THE PREFERRED EMBODIMENTS

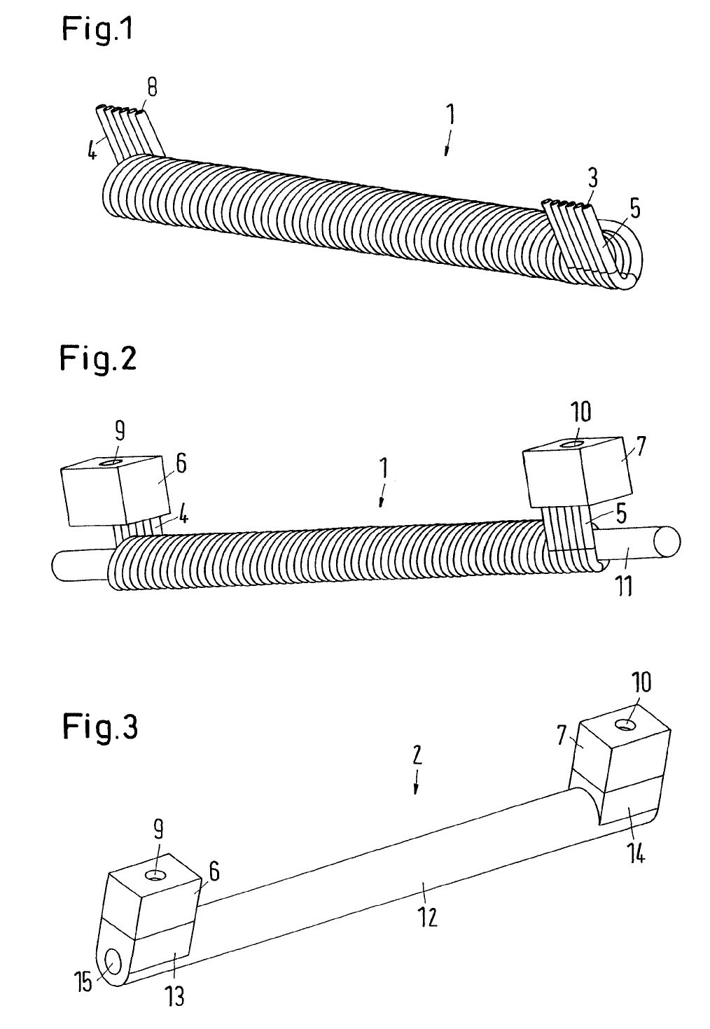

FIG. 1 shows a tube spiral 1 of a fluid line 2. The tube spiral 1 has several, in the present embodiment six, tubes 3, each tube 3 being wound along a helical line. All tubes 3 extend in parallel, so that the lift height of the helical line corresponds to the sum of the diameters of the six tubes 3.

The tubes 3 have ends 4, 5, which extend tangentially from the tube spiral 1. In other words, the ends 4, 5 of the tubes 3 are parallel to a first plane and vertical to a second plane, which extend through the axis of the tube spiral 1. This results in a short component length of the tube spiral with ends 4, 5. Instead of an alignment of the tube ends 3 in the purely tangential direction, it is also possible to bend the tube ends 3 in another angle, for example parallel to the axis of the tube spiral, if this is advantageous for certain mounting conditions.

FIG. 2 shows the tube spiral 1 before insertion into an injection moulding tool. Connecting elements 6, 7 are located at both tube ends 4, 5. These connecting elements 6, 7 can be connected to the ends 4, 5 of the tubes 3 in a suitable manner, for example by soldering, welding, gluing or another process.

The connecting elements 6, 7 serve the purpose of connecting openings 8 of the tube ends 4, 5 to a common fluid connection. For this purpose, the connecting element 6 has an opening 9 and the connecting element 7 has an opening 10, which can subsequently be used to connect the fluid line 2 to other components.

Before insertion into the injection moulding tool, a core 11 is inserted into the tube spiral 1, the core 11 being meant to keep a hollow inside the tube spiral 1 free during the injection moulding. In this connection, the all sides of the core 11 should have a uniform distance to the tube spiral 1, so that all the tubes 3 of the tube spiral 1 can be completely covered with the plastic material.

FIG. 3 shows the fluid line 2 after the injection moulding process. The complete tube spiral 1 and also the tube ends 3, 4 are surrounded by a coat 12 of cured liquid silicone rubber. The coat 12 has projections 13,14, formed by moulding, which extend up to the connecting elements 6, 7.

Now, the core 11 is removed from the fluid line 2, so that the fluid line 2 has a cylindrical hollow 15.

Liquid silicone rubbers, which are suited for the coat 12, could be Dow Corning SILASTIC LSR, Wacker ELASTOSIL LR and GE-Bayer Silopren LSR.

The use of liquid silicone rubber involves the advantage that the coat 12 is highly flexible and also high-temperature resistant. Liquid silicone rubber is a two-component plastic material. In this plastic material, the two low-viscous components do not cure until they are brought together under heat absorption. If, before inserting the tube spiral 1 in an injection mould, the tube spiral 1 and/or the injection mould is heated, the curing process in the injection mould will be so fast that short fixed cycles can be realised. The curing can be achieved within a few seconds.

The low-viscous components of liquid silicone rubber permit the supply to the injection mould of the mixture of the two components at a relatively low pressure of a few bar. Accordingly, the tubes 3, which are preferably made of a metal, do not have to be supported from the inside. They can have relatively thin walls without risking to be deformed during the injection moulding.

As can be seen from FIG. 3, not only the tubes 3, but also the connecting elements 6, 7, which are fixed on the tubes 3, are embedded in the plastic material. Thus, also the joining spots at the connection between the tubes 3 and the connecting elements 6, 7 are reliably protected against corrosion attacks.

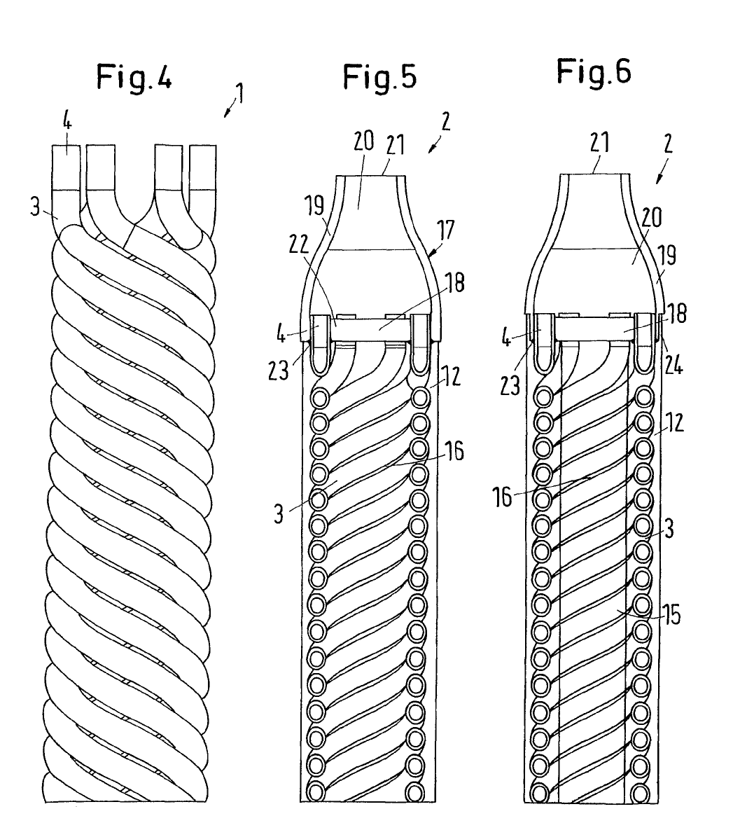

FIG. 4 shows a modified embodiment of a tube spiral 1, in which the ends 3 have been bent in parallel with the axis of the tube spiral 1. Also here, six tubes 3 are concerned. In the central area of the view according to FIG. 4, the tubes are located above each other two by two, so that only four ends 4 of the tubes 3 can be seen.

The other end of the tube spiral 1 can be made in the same way as the end shown. However, it is also possible to make the other end of the tube spiral 1 as described in connection with, for example, FIG. 1.

FIG. 5 shows a fluid line 2 with the tube spiral 1 of FIG. 4 in a section. The plastic material of the coat 12 is, in a manner of speaking, drawn to be transparent, so that the tubes 3 can be seen.

Between the tubes 3 distances 16 are made, which are also filled with the liquid silicone rubber of the coat 12. Generally, in connection with shown finished lines, the liquid silicone rubber is always cured. The liquid silicone rubber prevents a rubbing of the tubes 3 on each other, when the fluid line 2 is exposed to vibrations. In the embodiment according to FIG. 5 a hollow 15 is not provided. On the contrary, the liquid silicone rubber does not only surround the tubes 3 in the form of a coat, it also fills the whole inside.

Compared to the FIGS. 2 and 3, the fluid line 2 has a modified embodiment of a connecting element 17. The connecting element 17 has a basis plate 18, which surrounds a connecting chamber 20 together with a housing element 19. The housing element 19 has an opening 21 in the direction of the connecting chamber 20.

For each end 4 of the tubes 3, the basis plate 18 has a through bore 22. The end 4 is guided through the through bore 22 and connected to the basis plate 18 by means of a solder or weld seam 23. The solder or weld seam 23 has two tasks. Firstly, it mechanically fixes the ends 4 of the tubes 3 to the basis plate 18. Secondly, it seals the connecting chamber 20 in the direction of the tube spiral 1.

As the connection between the ends 4 and the basis plate 18 is made before making the coat 12 of liquid silicone rubber, also the solder or weld seams 23 are covered by the coat 12 of liquid silicone rubber. Thus, external influences are prevented from corroding this solder or weld seam 23.

FIG. 6 shows a modified embodiment of the fluid line 2. Here, the same elements are provided with the same reference numbers. Also here, the liquid silicone rubber of the coat 12 is made to be “transparent”, so that the tubes 3 can be seen.

Contrary to embodiment of FIG. 5, the hollow 15 is provided again, which was filled by the core 11 during the injection moulding process. However, it can be seen that both the radial inside and the radial outside of the tubes 3 are covered by the coat 12 of cured liquid silicone rubber. Also here, distances are provided between the tubes 3, said distances being filled by the cured liquid silicone rubber.

The side of the housing element 19 facing the tubes 3 is provided with a circumferential recess 24. This recess 24 is located in the area of the basis plate 18. If, however, the housing element 19 extends over the basis plate 18 in the direction of the tubes 3, the recess 24 can also be placed elsewhere. The coat 12 extends into the recess 24. Thus, an even better sealing in the direction of the weld or solder seams 23 is achieved.

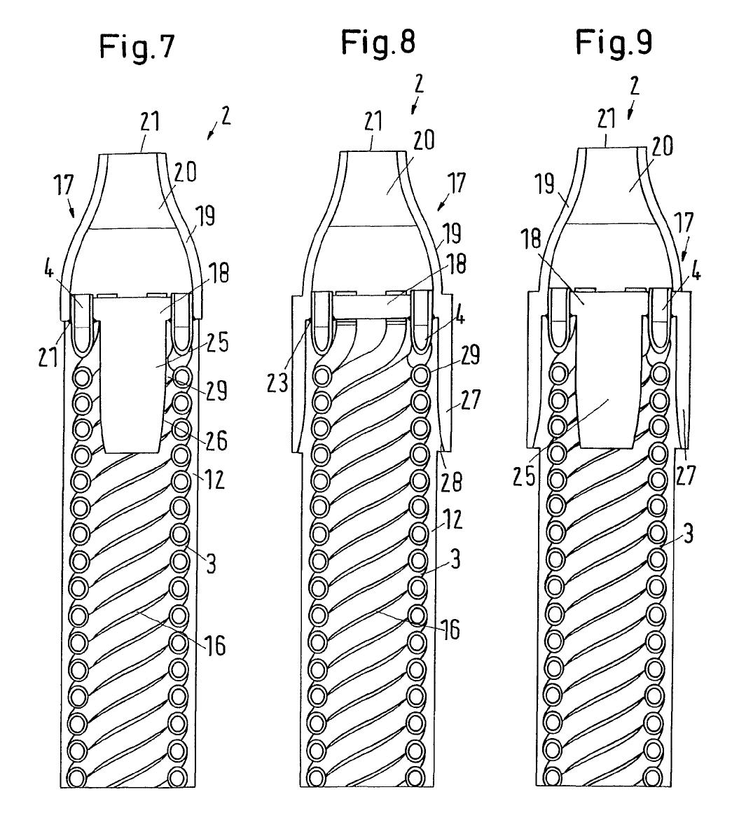

FIG. 7 shows an embodiment that is much like the embodiment according to FIG. 5. The same elements are provided with the same reference numbers. Also here, the coat 12 of cured liquid silicone rubber is made to be transparent. It completely fills the tube spiral 1.

The connecting element 17 has a projection 25, which does, over a length corresponding at least to the inner diameter of the tube spiral 1, extend into the spiral 1 of the tubes 3. As shown, the projection 25 can be made in one piece with the basis plate 18. However, it can also be made as a separate component, which is fixed on the basis plate 18.

On its complete circumference, the projection 25 has a radial distance 29 to the tubes 3, which again is filled with the cured liquid silicone rubber.

At its end, the projection 25 has a conical tapering 26, in which the distance to the tubes 3 increases.

With this embodiment, the end area of the tube spiral is relieved. The largest stresses in the individual tubes 3 of metal occur after the winding and the placing of the ends 4 at the connecting element 17. On the one side they occur at the transition from the spiral structure to the axial ends 4, mainly caused by the mechanical deformation. On the other side they occur at the fixing spots of the tube ends 4 on the basis plate 18, mainly caused by thermal load.

By means of the projection 25, these statically “prestressed” areas of the line 2 can be separated from the spots, which are dynamically loaded during operation, particularly by vibrations. This reduces the risk of a rupture of the line.

The radial distance 29 between the tubes 3 and the projection 25 as well as the conical end 26 permit a certain flexibility of the line 2, also in the area of the projection 25, without giving rise to excessive stress loads.

FIG. 8 shows an embodiment of the connecting element 17 modified in comparison with FIG. 7. Same parts and parts with the same function are provided with the same reference numbers as in FIG. 7. Also here the coat 12 of cured liquid silicone rubber is shown to be transparent.

The connecting element 17 has a circumferential flange 27, which surrounds the tubes 3 in their end area in the manner of a cover. At its open end, the flange 27 has a diameter extension 28. The flange 27 has a radial distance 29 to the tubes 3, or their ends 4, respectively. The coat 12 extends into this distance 29.

Also the flange 27 extends in the axial direction of the fluid line 2 over a length, which corresponds to at least the outer diameter of the tube spiral 1. The mode of functioning is substantially the same as for the projection 25. Additionally, an even better protection of the solder or weld seam 23 against external influences is achieved.

FIG. 9 shows an embodiment combining the features of the connecting elements of FIGS. 7 and 8. The connecting element 17 has both a projection 25 and a circumferential flange 27. This ensures an even better support of the ends 4 of the tubes 3.

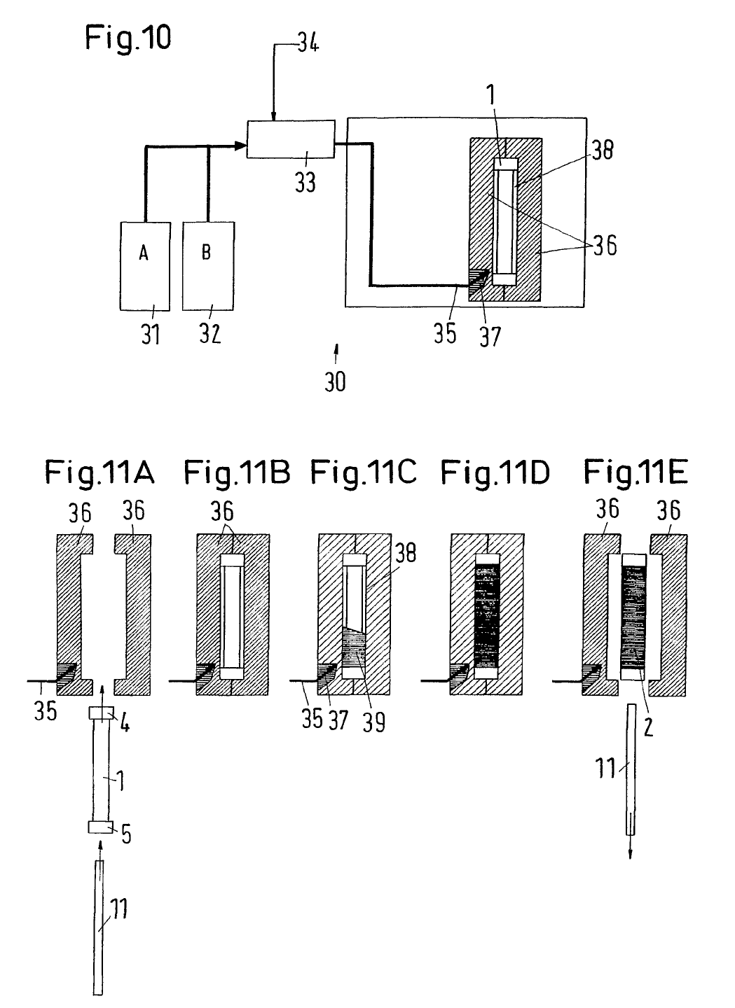

FIG. 10 is a schematic view of an injection moulding plant 30 for embedding the tube spiral 1 in the coat 12. Two components A, B are supplied to a mixer 33 from two containers 31, 32. When needed, also a colour 34 can be supplied to the mixer 33. Via a tube the mixed components A, B are supplied to an injection mould 36. The injection mould is also called “injection tool”. The injection mould 36 has a connection 37, in which the tube 35 ends. The connection 37 is cooled. This prevents the mix of the two components A, B from increasing their viscosity and curing already in the connection 37. Besides, the injection mould 36 is preheated. Before insertion, the tube spiral 1 can be heated, for example to a temperature in the range from 150 to 200° C. The heat supply to the mixed components of the liquid silicone rubber ensures a very fast curing in the hollow 38 of the injection mould 36. The cooling of the connection 37 permits the manufacturing of a practically boss-free injection moulded part in the form of a fluid line 2.

FIG. 11 is a schematic view of some process steps of the manufacturing of the fluid line. Same elements as in the FIGS. 1 to 10 are provided with the same reference numbers.

The injection mould 36 is opened (FIG. 11a). The tube spiral 1 with the connecting elements 4, 5 and, if required, the core 11 is inserted in the injection mould 36, and the injection mould 36 is closed (FIG. 11b). Then, liquid silicone rubber 39 is supplied via the tube 35 and the cooled connection 37 (FIG. 11c). As soon as the hollow 38 is filled (FIG. 11d), a heat supply and/or an amount of time ensures curing of the liquid silicone rubber 39. As soon as the liquid silicone rubber 39 has cured, the injection mould 36 is opened, and the finished fluid line 2 can be removed (FIG. 11e). A possible core 11 must then be removed. The fluid line 2 with practically no bosses is the result.

While the present invention has been illustrated and described with respect to a particular embodiment thereof, it should be appreciated by those of ordinary skill in the art that various modifications to this invention may be made without departing from the spirit and scope of the present invention.

What is claimed is:

1-21. (canceled)

22. A method for manufacturing a fluid line, in which several tubes are wound in parallel along a helical line, provided at least at one end with a connecting element and embedded in a plastic material, wherein a liquid silicone rubber is used as plastic material and that the connecting element has a projection that extends into a chamber circumscribed by the helical line.

23. The method according to claim 22, wherein the liquid silicone rubber is applied to the tubes by means of an injection moulding process.

24. The method according to claim 23, wherein the tubes are inserted in an injection mould, and subsequently a component mix of the liquid silicone rubber is inserted into the injection mould through a cooled inlet passage.

25. The method according to claim 24, wherein the tubes are heated before insertion into the injection mould.

26. The method according to claim 24, wherein the injection mould is heated.

27. A fluid line with several tubes wound in parallel along a helical line and having, at least at one end, a common connecting element, the tubes being embedded in a plastic material, wherein the plastic material is a cured liquid silicone rubber and that the connecting element has a projection that extends into a chamber circumscribed by the helical line.

28. The fluid line according to claim 27, wherein the cured liquid silicone rubber covers a connection arrangement between the tubes and the connecting element.

29. The fluid line according to claim 27, wherein the tubes have a mutual distance, in which the cured liquid silicone rubber is located.

30. The fluid line according to claim 27, wherein the cured liquid silicone rubber surrounds a hollow inside an inner chamber surrounded by the tubes.

31. The fluid line according to claim 27, wherein the connecting element is located outside the longitudinal axis of the helical line.

32. The fluid line according to claim 31, wherein the ends of the tubes extend tangentially from the helical line.

33. The fluid line according to claim 27, wherein the ends of the tubes are bent in parallel to the longitudinal axis of the helical line.

34. The fluid line according to claim 27, wherein the connecting element has a basis plate with through openings, into which the ends of the tubes are inserted.

35. The fluid line according to claim 34, wherein the basis plate, together with a housing element, encloses a connection chamber, the housing element having an opening.

36. The fluid line according to claim 34, wherein the ends of the tubes are connected to the basis plate via a soldered or welded connection.

37. The fluid line according to claim 27, wherein the end of the connecting element facing the tubes comprises a circumferential recess, into which the cured liquid silicone rubber extends.

38. The fluid line according to claim 27, wherein the projection has a length, which at least corresponds to the diameter of the helical line.

39. The fluid line according to claim 27, wherein the end of the projection is made to be conical.

40. The fluid line according to claim 27, wherein a radial distance is provided between the projection and the tubes, the radial distance being filled with cured liquid silicone rubber.

41. The fluid line according to claim 27, wherein the connecting element has a circumferential flange extending in the direction of the tubes, the flange surrounding the helical line in an end area.
